(19) United States
(12) Patent Application Publication
(10) Pub. No.: US 2025/0201007 A1
(43) Pub. Date: Jun. 19, 2025

(54) SYSTEMS AND METHODS FOR AUTOMATIC THREE-DIMENSIONAL OBJECT DETECTION AND ANNOTATION

(71) Applicant: Torc Robotics, Inc., Blacksburg, VA (US)

(72) Inventors: Syed Taha Shoaib, Blacksburg, VA (US); Dalong Li, Blacksburg, VA (US)

(21) Appl. No.: 18/545,110

(22) Filed: Dec. 19, 2023

(51) Int. Cl. G06V 20/70; G01S 7/481; G01S 17/89; G06V 20/58; G06V 20/64

(52) U.S. Cl. CPC G06V 20/70; G01S 7/4814; G01S 17/89; G06V 20/64; G06V 20/58

(57) ABSTRACT

A method for automatically digitally annotating a three-dimensional object in a scene includes capturing an image of the scene using a camera, capturing a point cloud representing the scene using a LiDAR system, and determining a two-dimensional boundary of the three-dimensional object contained in the image. The method further includes determining a subset of points of the point cloud contained within the two-dimensional boundary and assigning a unique identifier to the subset of points contained within the two-dimensional boundary.

### TECHNICAL FIELD

The field of the disclosure relates generally to object annotation and, more specifically, to automatic three-dimensional object annotation using camera images and LiDAR point clouds.

### BACKGROUND OF THE INVENTION

Accurately and expeditiously determining the location of obstacles, such as vehicles and pedestrians, is critical for the safety and performance of autonomous or semi-autonomous vehicles. Various methodologies have been developed to determine object boundaries in two-dimensional camera images or in three-dimensional LiDAR point clouds. Once object boundaries have been determined, unique identifiers may be assigned to the objects for analytical or modeling purposes, commonly referred to as object annotation.

Determining object boundaries in two-dimensional camera images may be performed semi-automatically using computational methods, e.g., object detection that determines a two-dimensional box around an object, or object segmentation that determines a more accurate perimeter around the shape of an object. Determination of a three-dimensional boundary of an object and annotation in a LiDAR point cloud is considerably more challenging and is a computationally expensive process requiring extended computational times as well as large memory storage requirements. Furthermore, three-dimensional object boundary determination and annotation requires at least some human intervention for correcting and confirming the three-dimensional object boundaries. As such, three-dimensional object boundary determination and annotation has not yet been fully automated. In some cases, object boundary determination and annotation in LiDAR point clouds having a plurality of crowded objects requires manual determination.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a method for automatically digitally annotating a three-dimensional object in a scene is provided. The method includes capturing an image of the scene using a camera, capturing a point cloud representing the scene using a LiDAR system, and determining a two-dimensional boundary of the three-dimensional object contained in the image. The method further includes determining a subset of points of the point cloud contained within the two-dimensional boundary and assigning a unique identifier to the subset of points contained within the two-dimensional boundary.

In another aspect, a system for automatically digitally annotating a three-dimensional object in a scene is provided. The system includes a LiDAR system configured to capture a point cloud representing the scene and a camera configured to capture an image of the scene. The system further includes a computing system including a memory for storing executable instructions and data, and a processor communicatively coupled to the memory, the LiDAR system, and the camera. Upon execution of the executable instructions, the processor is configured to receive the point cloud and the image, determine a two-dimensional boundary of the three-dimensional object contained in the image, and determine a subset of points of the point cloud contained within the two-dimensional boundary. The processor is further configured to assign a unique identifier to the subset of points contained within the two-dimensional boundary.

In yet another aspect, a computer-implemented method for automatically digitally annotating a three-dimensional object in a scene is provided. The method includes receiving an image of the scene captured using a camera, receiving a point cloud representing the scene and captured using a LiDAR system, and determining a two-dimensional boundary of the three-dimensional object contained in the image. The method further includes determining a subset of points of the point cloud contained within the determined two-dimensional boundary and assigning a unique identifier to the subset of points contained within the two-dimensional boundary.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an embodiment of an object annotation system;

FIG. 2 is an example illustration of a camera image and a two-dimensional boundary for use with the object annotation system shown in FIG. 1;

FIG. 3 is an example illustration of a LiDAR point cloud overlaid onto the image shown in FIG. 2;

FIG. 4 is an example illustration of the LiDAR point cloud overlaid onto the image as shown in FIG. 3 including a three-dimensional boundary;

FIG. 5 is an illustration of an example three-dimensional object boundary including a cuboid shape; and

FIG. 6 is a flowchart of an example method for annotating an object for use with the object annotation system shown in FIG. 1.

Corresponding reference characters indicate corresponding parts throughout the several views of the drawings. Although specific features of various examples may be shown in some drawings and not in others, this is for convenience only. Any feature of any drawing may be reference or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Embodiments of the object annotation system disclosed herein enable automatic or semi-automatic determination of three-dimensional object boundaries and digital annotation having improved computational efficiency, e.g., decreased computational times and decreased computational load, as well as improved accuracy. The automatic implementation reduces or eliminates the need for human intervention. Aspects of the systems and methods of object annotation described herein are not limited to the specific embodiments described herein, but rather, components of the object annotations may be used independently and separately from other components described herein

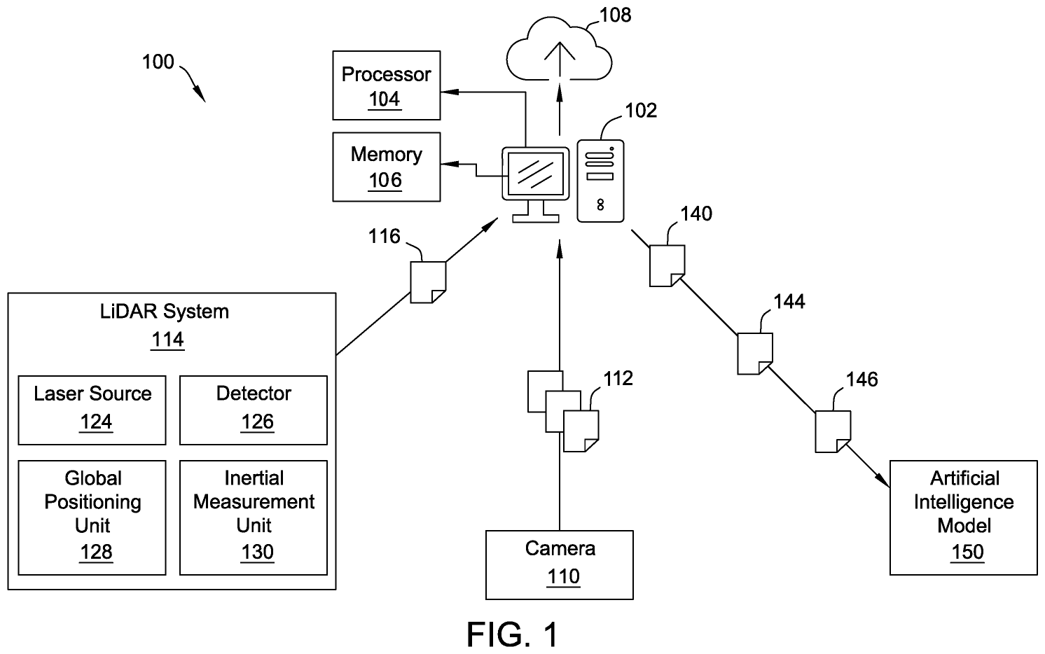

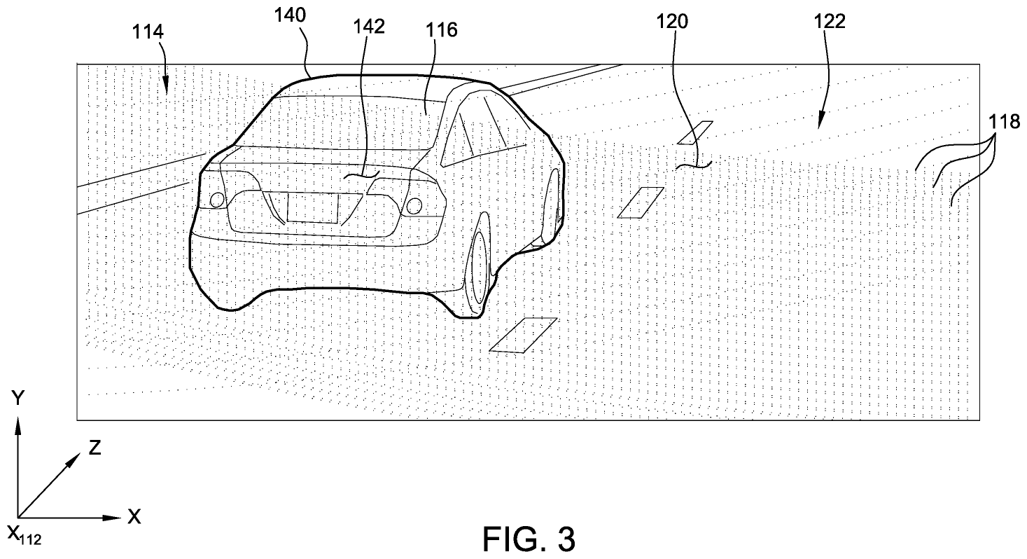

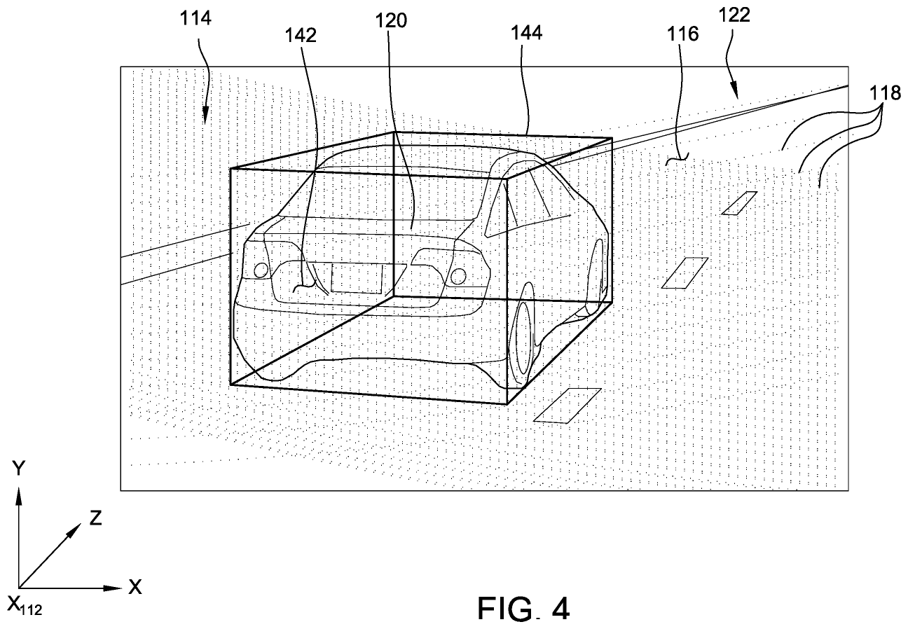

FIG. 1 is a schematic diagram of an embodiment of an object annotation system 100. The object annotation system 100 includes a computing system 102 including a processor 104 and a memory 106. The computing system 102 may be communicatively coupled to a storage device 108, such as a cloud-based storage device 108. The object annotation system 100 includes a camera 110 for capturing images 112 of a given scene and a Light Detection and Ranging (LiDAR) system 114 for capturing a LiDAR point cloud 116 including a plurality of points 118 representing the scene (shown in FIGS. 3-4).

In some embodiments, the camera 110 and one or more components of the LiDAR system 114 may be coupled to an autonomous or a semi-autonomous vehicle (not shown). Computing system 102 may be positioned locally within such an autonomous vehicle or positioned remotely from the autonomous vehicle. The computing system 102 is communicatively coupled to the LiDAR system 114 and the camera 110 over one or more wired or wireless connections, such that the computing system 102 may receive/retrieve images 112 and LiDAR point clouds 116 locally or remotely from the vehicle.

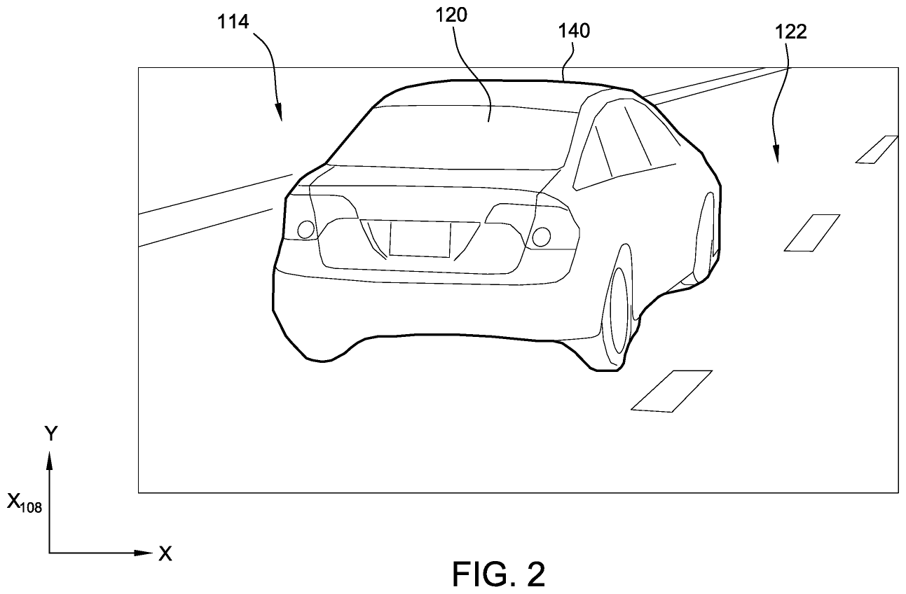

The camera 110 includes any suitable device for capturing RGB images having a suitable resolution enabled to capture images 112 of one or more three-dimensional objects 120 in the scene, or a field of view 122 (shown in FIGS. 2-4). The images 112 (e.g., a plurality of individual RGB image frames) include a plurality of pixels located in a two-dimensional coordinate frame X₁₀₈. The object 120 is embodied herein as a vehicle and the field of view 122 is embodied as a roadway on which the vehicle is traveling. In other embodiments, the camera 110 may capture images 112 of any suitable or selected field of view. In some embodiments, the camera 110 may capture images 112 of the surroundings of an autonomous or semi-autonomous vehicle, such as roadways, intersections, parking lots, and the like. In some embodiments, the images 112 may include additional or alternative objects 120, for example and without limitation, pedestrians, streetlights, traffic signs, road markings, other vehicles, medians, foliage, and the like. In some embodiments, the object annotation system 100 includes a plurality of cameras 110 positioned to capture images 112 from various perspectives, or fields of view. In some embodiments, the camera 110 may be mounted to a movable frame enabling the field of view of the camera 110 to be adjusted, e.g., manually, or automatically via a controller.

The camera 110 may have a data collection rate of approximately 50 frames/sec. The camera 110 may have any other suitable data collection rate enabling the object annotation system 100 to function as described herein. The computing system 102 may receive/retrieve images 112 periodically in batches, or continuously, e.g., every second or millisecond. The camera 110 may have any other suitable data transmission rate enabling the object annotation system 100 to function as described herein. The computing system 102 may store images 112 within the storage device 108 and/or the memory 106.

The LiDAR system 114 includes a laser source 124 for emitting pulses of light (e.g., ultraviolet, visible, and/or near infrared light) and a detector 126 for detecting a returning pulse of light that has been reflected off of objects 120 in the field of view. In some embodiments, the LiDAR system 114 includes or is coupled to a global positioning system 128 or an inertial measurement unit 130. In some embodiments, the LiDAR system 114 includes a plurality of laser sources or a plurality of detectors. The LiDAR system 114 may include additional and/or alternative components, e.g., timing electronics, to enable the LiDAR system 114 or the object annotation system 100 to function as described herein.

The LiDAR system 114 may have a data collection rate of approximately a million points/sec. The LiDAR system 114 may have any other suitable data collection rate enabling the object annotation system 100 to function as described herein. The computing system 102 may receive/retrieve the LiDAR point clouds 116 periodically in batches, and/or continuously, e.g., every second or millisecond. The LiDAR system 114 may have any other suitable data transmission rate enabling the object annotation system 100 to function as described herein. The computing system 102 may store images 112 and/or the LiDAR point clouds 116 within the storage device 108.

Each individual point 118 of the LiDAR point cloud 116, collected by the LiDAR system 114, is associated with a three-dimensional location represented by a set of coordinates. In some embodiments, the coordinates may be represented using a conventional cartesian coordinate system, X₁₁₂, such that each point 118 includes a location including an x-coordinate, a y-coordinate, and a z-coordinate. In some other embodiments, the three-dimensional location may be represented using any other suitable coordinate system, e.g., a polar coordinate system. Each individual point 118 may also be associated with an intensity value and a color value. The intensity value is associated with a brightness indicating a relative reflected strength of the reflected laser resulting in part from the reflectivity of an object, e.g., a brighter intensity, or greater intensity value, indicates a more reflective object as compared to a dimmer intensity, or lesser intensity value. In some embodiments, each individual point 118 may also be associated with a color value, e.g., red, green, blue (RGB) color value, adding contextual information to the LiDAR point cloud 116. The color values may be assigned to points 118 using images 112 captured by the camera 110. The points 118 collected by the LiDAR system 114 may include any additional or alternative data enabling the LiDAR system 114 and the object annotation system 100 to function as described herein.

The computing system 102 determines a two-dimensional (2D) object 140 boundary using the images 112. The computing system 102 aligns, or registers, the images 112 with the LiDAR point cloud 116. The computing system 102 determines a subset of points 118 contained in the 2D object boundary 140, referred to herein as object points 142. The computing system 102 determines a three-dimensional (3D) object boundary 144 using the object points 142. The computing system 102 assigns, digitally, an object annotation 146 to the object points 142 or the 2D or 3D object boundaries 140, 144 for each object 120. Digital object annotation 146 may include a unique identifier distinguishing each individual object from other objects contained in the images 112/LiDAR point cloud 116. In some embodiments, the digital object annotations 146 include a category indicating a type of object. For example, and without limitation, a category of objects includes vehicles, pedestrians, foliage, stationary objects, among others.

The object annotation system 100 may include or is associated with a machine learning, or artificial intelligence (AI), model 150 that is communicatively connected to the computing system 102. The computing system 102 may utilize the object boundaries 140, 144 or the annotations 146 for model training, tuning, or validation during development of the machine learning model 150. Additionally, or alternatively, the computing system 102 may apply object boundaries 140, 144 and annotations 146 to the machine learning model 150 during a model prediction or application process. The computing system 102 and the AI model 150 may utilize the object boundaries 140, 144 and annotations 146 for any suitable analytical methods or processes. In some embodiments, the machine learning model 150 may be used in connection with an autonomy computing system (not shown) for an autonomous or semi-autonomous driving system or autonomous vehicles. For example, the machine learning model 150 may be used to determine one or more driving commands to be executed by one or more systems or subsystems of an autonomous vehicle.

FIG. 2 is an example illustration of an example image 112 showing the object 120 and the 2D object boundary 140 determined by the computing system 102. The 2D object boundary 140 of the object 120 is a segmentation boundary including a plurality of individual line segments such that the 2D object boundary 140 is an outline of a perimeter of the object in the image 112. In some alternative embodiments, the 2D object boundary 140 may be an object detection boundary including a box surrounding the object. The 2D object boundary may be determined using any suitable process, e.g., color, saturation, and/or hue detections and/or a machine learning model.

FIG. 3 is an example illustration of an example view of the LiDAR point cloud 116, including a plurality of points 118 overlaid onto and aligned with the image 112 including the 2D object boundary 140. The computing system 102 receives the images 112 and the LiDAR point cloud 116, and the computing system 102 aligns the LiDAR point cloud 116 with the image 112, e.g., using a change of basis process. For example, a change of basis matrix may be used to transform, using matrix multiplication, the LiDAR point cloud 116, in their original coordinate system, into the new coordinate system of the image 112. In some embodiments, the LiDAR system 114 and the camera 110 system may include one or more ground control datums that may be used to align the images 112 with the LiDAR point cloud 116.

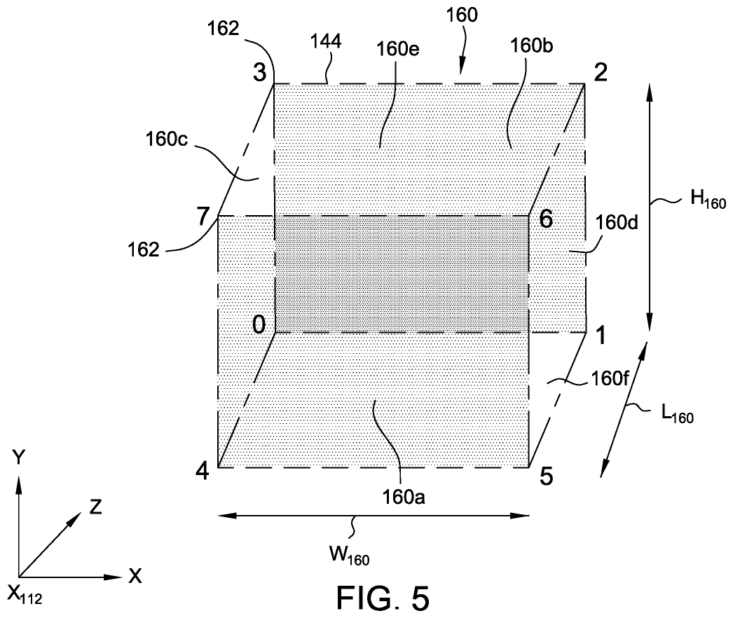

FIG. 4 is an example illustration of an example view of the LiDAR point cloud 116 overlaid onto and aligned with the image 112 and a determined three-dimensional (3D) boundary 144 of the object is shown overlaid onto and aligned with the images 112 and the LiDAR point cloud 116. The 3D object boundary 144 may be determined by the computing system 102 using one or more extrema of the points 142, e.g., the subset of points 118 contained in the 2D object boundary 140, e.g., minimum and maximum, to determine each facet of the 3D object boundary 144, e.g., a cuboid 160 having 6 facets, described in reference to FIG. 5. In some embodiments, the 3D object boundary 144 includes a minimum distance, e.g., in the z-direction, of an object point 142 for defining the front surface and the maximum distance of an object point 142 for defining the rear surface. In some embodiments, determining the 3D object boundary 144 includes the computing system 102 determining a left most point, a right most point, a highest point, and a lowest point in the object points 142 for defining a left and right surface and a top and bottom surface.

FIG. 5 is an illustration of an example 3D object boundary 144. In some embodiments, the 3D object boundary 144 is embodied as a cuboid 160 having a height H₁₆₀, a width W₁₆₀, and a length L₁₆₀. The 3D object boundary 144 includes six facets including a front surface 160a, a rear surface 160b, a right surface 160c and a left surface 160d, and a top surface 160e and a bottom surface 160f and eight corners 162, labeled 0-7 in FIG. 5. In some embodiments, the 3D object boundary 144 may include other polygonal shapes having any suitable number of facets or corners.

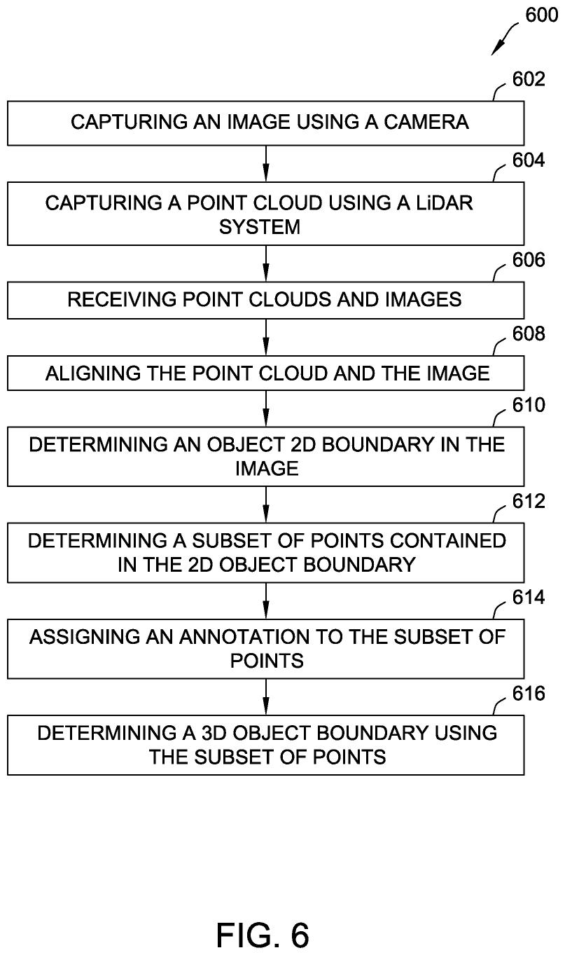

FIG. 6 is a flow diagram of a method 600 of automatically annotating an object for use with the object annotation system 100 shown in FIG. 1. The method 600 includes capturing 602 an images 112 using the camera 110 and capturing 604 the LiDAR point cloud 116 using the LiDAR system 114.

The method 600 includes receiving or retrieving 606 at the computing system 102 images 112 and LiDAR point clouds 116. In some embodiments, method 600 includes the computing system 102 saving the images 112 or the LiDAR point clouds 116 in the memory or the storage device 108.

The method 600 includes the computing system 102 aligning 608 the images 112 and the LiDAR point cloud 116. The method 600 may include the computing system 102 determining a 2D coordinate, in the coordinate system X 108 of the image 112, for each of the points 118 in the LiDAR point cloud 116.

The method 600 includes the computing system 102 determining 610 the 2D object boundary 140 for any, or all, of the objects 120 contained in the image 112. The computing system 102 may determine 610 the 2D object boundary 140 using an instance segmentation process to detect unique objects in the image 112, and then the computing system 102 uses the instance segmentation to create a polygon boundary.

The method 600 includes the computing system 102 determining 612 a subset of points 118 contained within the 2D object boundary 140, also referred to herein as object points 142. The computing system 102 may determine 612 subsets of points 118 contained in the 2D boundaries 140 by comparing a location of each point 118 in the LiDAR point cloud 116 to the 2D object boundary 140.

The method 600 includes assigning an annotation, e.g., a unique object identifier, to the determined subset of the points 118, e.g., points 142, contained in the 2D object boundary 140.

In some embodiments, the method 600 may include the computing system 102 compiling the 3D coordinates of points 118 in the 3D coordinate frame X₁₁₂ of the LiDAR system 114 and the determined 2D coordinates of points 118 in the 2D coordinate frame X₁₀₈ of the images 112 into a data structure, e.g., such as a Python Toolkit Pandas, creating a mapping between the 3D coordinates and the determined 2D coordinates for the points 118 in the LiDAR point cloud 116.

The method 600 further includes the computing system 102 determining 616 the 3D object boundary 144. In some embodiments, determining 616 the 3D object boundary 144 may include the computing system 102 determining one or more extrema of the points 142, e.g., minimum, and maximum, to determine each of the facets. In some embodiments, determining 616 the 3D object boundary 144 includes determining the cuboid 160 having 6 facets. For example, determining 616 the 3D object boundary 144 may include determining the front surface 160a and the rear surface 160b using the 3D coordinates of object points 142, e.g., the subset of the points 118 contained in the 2D object boundary 140. In some embodiments, determining 616 the 3D object boundary 144 includes determining the minimum distance, e.g., in the z-direction, of an object point 142 for defining the front surface 160a and the maximum distance of an object point 142 for defining the rear surface 160b. Determining 616 the 3D object boundary 144 may include the computing system 102 determining a left most point, a right most point, a highest point, and a lowest point in the object points 142 for defining a left and right surface 160c, 160d and an top and bottom surface 160c, 160f.

In some embodiments, the method 600 further includes the computing system 102 assigning the digital object annotation 146 after determination of the 3D object boundary 144. In some embodiments, the method 600 includes the computing system 102 utilizing one or more of the 2D object boundary 140, the 3D object boundary 144, and/or the assigned digital object annotation 146 to build, train, tune, or validate the machine learning model 150.

An example technical effect of the methods, systems, and apparatus described herein includes at least one of: (a) improved computational efficiency, decreased computation times and computation consumption/costs when determining 3D boundaries of objects (b) Eliminating the requirement of manual 3D object detection, or (c) improved accuracy of 3D object detection.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the term's processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method for automatically digitally annotating a three-dimensional object in a scene, the method comprising:
capturing an image of the scene using a camera;
capturing a point cloud representing the scene using a LiDAR system;
determining a two-dimensional boundary of the three-dimensional object contained in the image;
determining a subset of points of the point cloud contained within the two-dimensional boundary; and
assigning a unique identifier to the subset of points contained within the two-dimensional boundary.

2. The method of claim 1 further comprising determining a three-dimensional boundary of the three-dimensional object using extrema of the subset of points.

3. The method of claim 2 further comprising training a machine learning model using the three-dimensional object boundary and the unique identifier.

4. The method of claim 2, wherein the three-dimensional boundary of the three-dimensional object includes a cuboid having six facets.

5. The method of claim 1, wherein the LiDAR system includes at least one of a laser source and a detector.

6. The method of claim 1, wherein determining the two-dimensional boundary of the three-dimensional object includes determining an instance segmentation two-dimensional boundary.

7. The method of claim 1, wherein the unique identifier corresponds to a category of objects.

8. The method of claim 1, wherein points contained in the point cloud each include three-dimensional coordinates and an intensity value.

9. A system for automatically digitally annotating a three-dimensional object in a scene, the system comprising:
a LiDAR system configured to capture a point cloud representing the scene;
a camera configured to capture an image of the scene; a computing system including a memory for storing executable instructions and data, and a processor communicatively coupled to the memory, the LiDAR system, and the camera, the processor, upon execution of the executable instructions, configured to:
receive the point cloud and the image;
determine a two-dimensional boundary of the three-dimensional object contained in the image;
determine a subset of points of the point cloud contained within the two-dimensional boundary; and
assign a unique identifier to the subset of points contained within the two-dimensional boundary.

10. The system of claim 9, wherein the processor is further configured to determine a three-dimensional boundary of the three-dimensional object using extrema of the subset of points.

11. The system of claim 10, wherein the three-dimensional boundary of the three-dimensional object includes a cuboid having six facets.

12. The system of claim 9, wherein the LiDAR system includes at least one of a laser source and a detector.

13. The system of claim 9, wherein the processor is further configured to determine the two-dimensional boundary of the three-dimensional object using an instance segmentation two-dimensional boundary.

14. The system of claim 9, wherein the unique identifier corresponds to a category of objects.

15. The system of claim 9, wherein points contained in the point cloud each include three-dimensional coordinates and an intensity value.

16. The system of claim 9, where in the processor is further configured to train a machine learning model using the three-dimensional object boundary and the unique identifier.

17. A computer-implemented method for automatically digitally annotating a three-dimensional object in a scene, the method comprising:
receiving an image of the scene captured using a camera;
receiving a point cloud representing the scene and captured using a LiDAR system;
determining a two-dimensional boundary of the three-dimensional object contained in the image;
determining a subset of points of the point cloud contained within the determined two-dimensional boundary; and
assigning a unique identifier to the subset of points contained within the two-dimensional boundary.

18. The method of claim 17, wherein the method further includes determining a three-dimensional boundary of the three-dimensional object using extrema of the subset of points.

19. The method of claim 18, wherein the three-dimensional boundary of the three-dimensional object includes a cuboid having six facets.

20. The method of claim 17, wherein the LiDAR system includes at least one of a laser source and a detector.
